(19) United States
(12) Patent Application Publication
(10) Pub. No.: US 2014/0059088 A1
(43) Pub. Date: Feb. 27, 2014

(54) Tokenization of Date Information

(71) Applicant: Protegrity Corporation, George Town (KY)

(72) Inventors: Ulf Mattsson, Cos Cob, CT (US); Yigal Rozenberg, Wilton, CT (US); Raul Ortega, Westport, CT (US)

(73) Assignee: Protegrity Corporation, George Town (KY)

(21) Appl. No.: 13/969,173

(22) Filed: Aug. 16, 2013

Related U.S. Application Data
(60) Provisional application No. 61/691,392, filed on Aug. 21, 2012.

(51) Int. Cl. G06F 17/30

(52) U.S. Cl. CPC G06F 17/30943
USPC 707/803

(57) ABSTRACT

Financial regulations can require the storing of transaction date information when conducting financial transactions. To improve the security of storing such information, date information can be tokenized prior to storage. Client devices used in conducting and processing transactions can access date information rules and token tables for use in tokenizing date information. The client device can also require and use starting date when tokenizing date information. To tokenize the date information, a client device can convert the date information into an integer, for instance based on a number of days from a starting date, and can use the date integer as an input to one or more token tables. The token tables output a tokenized date integer, which can be converted into a tokenized date using a second starting date. The tokenized date can then be stored for subsequent access.

### CROSS REFERENCE TO RELATED APPLICATIONS

The application claims the benefit of Provisional Application No. 61/691,392 filed on Aug. 21, 2012, which is incorporated herein by reference.

### FIELD OF ART

This application relates to the field of data protection, and more specifically to the protection of date information.

### BACKGROUND

Many devices, websites, services, and applications implement various data protection techniques. Certain techniques involve the use of an encryption key or password that can be subject to interception or brute force guessing. Other methods may protect data but require extensive computing resources to encode and decode data. Such methods often fail to utilize various data format advantages when protecting the data. Often, systems implementing data protection techniques are required to protect date information, for instance date information describe dates and times of purchases, financial transactions, and the like. Thus, it may be advantageous to implement data protection techniques for date information that utilizes the advantages of the format of date information.

### SUMMARY

Client devices access and store date information and token tables, and tokenize the date information using the token tables to produce and store tokenized date information. Additional information, referred to herein as “starting date,” can be used to aid in tokenization, for instance in converting the date information to a tokenizable format, or to select one of more token tables for use in tokenization. The client devices, such as ATM machines, servers of banks or financial institutions, computers, smart phones, websites, web servers, and the like (collectively referred to as “client devices” henceforth), store one or more token tables that are received from a security system. These token tables may be updated or replaced periodically by the security system based on various conditions, such as specific time intervals, user requests, or security rules. In an embodiment, the tokenization of date information described herein is implemented within a client device via a plug-in or an application executing in the background of the client device.

As used herein, “tokenized date information” is used to refer to date information that has been tokenized using one or more token tables and that may have been encrypted or otherwise additionally protected. The client device can communicate with other devices or applications on devices to access specific date information requirements according to specific criteria, hereinafter “date information rules”, for use in tokenization, such as format rules, character requirements (e.g., letter case, digits, symbols, spacing and so forth), or sequence requirements (e.g., letter/number ordering).

The client device can validate the date information prior to tokenization. For instance, the client device can determine that a particular date falls within a particular valid date range. For example, the client device can be restricted to tokenize date information with dates that fall within the range “Jan. 1, 1800” to “Dec. 31, 2100.” Another example of a restriction can be that the date information can only include the current month or the prior week with respect to the actual date when the date information is tokenized. The client device can also be configured to verify that date information includes valid dates prior to tokenization, e.g., all month values are between 1 and 12, days are valid for the number of days in a given month, or if a day name is given (e.g., Saturday), that the date actually falls on that day. For example, the date information validation module can be configured to reject date information including a date such as “Apr. 31, 1972”, “14/28/91”, or “Friday, Jul. 25, 2012,” since April does not have a 31^{st} day, there is no such thing as a “14^{th}” month, and Jul. 25, 2012 was a Wednesday. Accordingly, using the token tables and date information rules, the client device is able to reject any received date information that does not includes dates that represent valid dates or that otherwise does not satisfy any imposed date information rules. Furthermore, access to the starting date and token tables provides a client device with the capability to recover the original date information based on the tokenized date information.

One embodiment is a computer implemented method of tokenizing date information. A computer system receives an item of date information, such as from a database, web page, electronic form, or the like. The computer system stores two different starting date values, a first starting date, and a second starting date. The computer system converts the received date information into a date integer representing the number of days between the first starting date and the received date. The computer system then tokenizes the date integer using one or more token tables to produce a new, second date integer. The computer system then converts the second date integer back into a second date, such that the second date occurs after the second starting date by a number of days that is equal to the second date integer.

Another embodiment is a tokenization system for data protection. The tokenization system includes an interface module, a date-to-integer conversion module, a tokenization engine, and an integer-to-date conversion. The interface module can receive and output a first and second date information, respectively, whereby the first date information can represents a first date. The date-to-integer conversion module can convert the first date information that it receives from the interface module into a first date integer, whereby the first date integer can represents a number of days between a first starting date to the first date. The tokenization engine can then tokenize the first date integer by using one or more token tables to produce a second date integer. Finally, the integer-to-date conversion module converts the second date integer into the second date information such that the second date information represents a second date and the second date occurs after a second starting date at a number of days that are equal to the second date integer.

The features and advantages described in this summary and the following detailed description are not all-inclusive. Many additional features and advantages will be apparent to one of ordinary skill in the art in view of the drawings, specification, and claims hereof.

### BRIEF DESCRIPTION OF DRAWINGS

FIG. 1 is a system environment diagram for a date information tokenization system, according to one embodiment.

FIG. 2 illustrates data flow within the tokenization system of FIG. 1, according to one embodiment.

FIG. 3 is chart illustrating the process of tokenizing date information, according to one embodiment.

The figures (Figs.) depict embodiments for purposes of illustration only. One skilled in the art will readily recognize from the following description that alternative embodiments of the structures and methods illustrated herein can be employed without departing from the principles of the invention described herein.

### DETAILED DESCRIPTION

Reference will now be made in detail to several embodiments, examples of which are illustrated in the accompanying figures. It is noted that wherever practicable, similar or like reference numbers can be used in the figures and can indicate similar or like functionality. The figures depict embodiments of the disclosed system (or method) for purposes of illustration only. One skilled in the art will readily recognize from the following description that alternative embodiments of the structures and methods illustrated herein can be employed without departing from the principles described herein.

### Tokenization Overview

The transmission and storage of sensitive data, such as passwords, credit card numbers, social security numbers, bank account numbers, driving license numbers, transaction information, date information, etc, can be challenging. Before sensitive data can be transmitted or stored, the sensitive data can be tokenized into tokenized data to prevent an unauthorized entity from accessing the data.

As used herein, the tokenization of data refers to the generation of tokenized data by querying one or more token tables mapping input values to tokens with the one or more portions of the data, and replacing the queried portions of the data with the resulting tokens from the token tables. Tokenization can be combined with encryption for increased security, for example by encrypting sensitive data using a mathematically reversible cryptographic function (e.g., datatype-preserving encryption or DTP), a one-way non-reversible cryptographic function (e.g., a hash function with strong, secret salt), or a similar encryption before or after the tokenization of the sensitive data. Any suitable type of encryption can be used in the tokenization of data. A detailed explanation of the tokenization process can be found in U.S. patent application Ser. No. 13/595,439, filed Aug. 27, 2012, which is hereby incorporated by reference.

As used herein, the term token refers to a string of characters mapped to an input string of characters in a token table, used as a substitute for the string of characters in the creation of tokenized data. A token can have the same number of characters as the string being replaced, or can have a different number of characters. Further, the token can have characters of the same type (such as numeric, symbolic, or alphanumeric characters) as the string of characters being replaced or characters of a different type.

Any type of tokenization can be used to perform the functionalities described herein. One such type of tokenization is static lookup table (“SLT”) tokenization. SLT tokenization maps each possible input values (e.g., possible character combinations of a string of characters) to a particular token. An SLT includes a first column comprising permutations of input string values, and can include every possible input string value. The second column of an SLT includes tokens, with each associated with an input string value of the first column. Each token in the second column can be unique among the tokens in the second column. Optionally, the SLT can also include one or several additional columns with additional tokens mapped to the input string values of the first column.

In some embodiments, to increase the security of tokenization, sensitive data can be tokenized two or more times using the same or additional token tables. For example, the first 8 digits of a 16 digit credit card number can be tokenized with an 8 digit token table to form first tokenized data, and the last 12 digits of the first tokenized data can be tokenized using a 12 digit token table to form second tokenized data. In another example, the first 4 digits of a credit card number are tokenized using a first token table, the second 4 digits are tokenized with a second token table, the third 4 digits are tokenized with a third token table, and the last 4 digits are tokenized with a fourth token table. Certain sections of the sensitive data can also be left un-tokenized; thus a first subset of the resulting tokenized data can contain portions of the sensitive data and a second subset of the tokenized data can contain a tokenized version of the sensitive data.

Dynamic token lookup table (“DLT”) tokenization operates similarly to SLT tokenization, but instead of using static tables for multiple tokenizations, a new token table entry is generated each time sensitive data is tokenized. A seed value can be used to generate each DLT. In some embodiments, the sensitive data or portions of the sensitive data can be used as a seed value to generate a DLT. DLTs can in some configurations provide a higher level of security compared to SLT but require the storage and/or transmission of a large amount of data associated with each of the generated token tables. While DLT tokenization can be used to tokenize data according to the principles described herein, the remainder of the description will be limited to instances of SLT tokenization for the purposes of simplicity.

The security of tokenization can be further increased through the use of initialization vectors (“IVs”). An initialization vector is a string of data used to modify sensitive data prior to tokenizing the sensitive data. Example sensitive data modification operations include performing linear or modulus addition on the IV and the sensitive data, performing logical operations on the sensitive data with the IV, encrypting the sensitive data using the IV as an encryption key, and the like. The IV can be a portion of the sensitive data. For example, for a 12-digit number, the last 4 digits can be used as an IV to modify the first 8 digits before tokenization. IVs can also be accessed from an IV table, received from an external entity configured to provide IVs for use in tokenization, or can be generated based on, for instance, the identity of a user, the date/time of a requested tokenization operation, based on various tokenization parameters, and the like. Data modified by one or more IVs that is subsequently tokenized includes an extra layer of security—an unauthorized party that gains access to the token tables used to tokenized the modified data will be able to detokenize the tokenized data, but will be unable to de-modify the modified data without access to the IVs used to modify the data.

### Tokenization System Overview

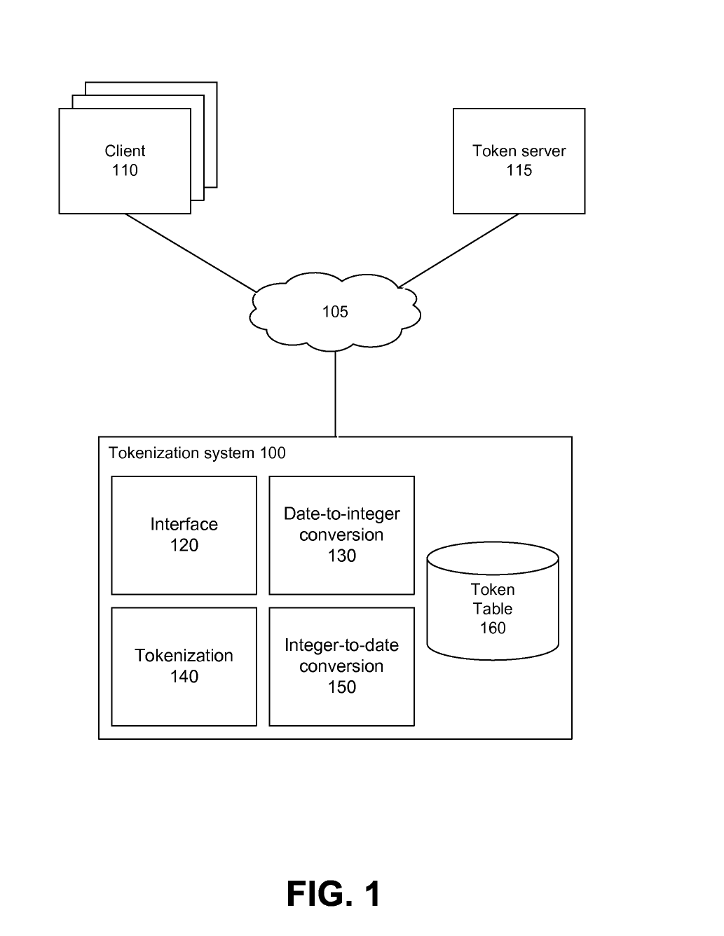

FIG. 1 is a system environment diagram for a date information tokenization system, according to one embodiment. The environment 100 of FIG. 1 includes a tokenization system 100, one or more clients 110, and a token server 115, communicatively coupled through a connecting network 105. A user or other entity can use a client 110 to access the tokenization system 100 via the network 105. Other embodiments of the system environment can contain different and/or additional components than those shown by FIG. 1.

A client 110 is a computing device capable of processing data as well as transmitting data to and receiving data from the other modules of FIG. 1 via the network 105. For example, the client 110 can be a desktop computer, laptop computer, smart phone, tablet computing device, server, payment terminal, or any other device having computing and data communication capabilities. Each client 110 includes one or more processors, memory, storage, and networking components. Each client 110 is coupled to the network 105 and can interact with other modules coupled to the network 105 using software such as a web browser or other application with communication functionality. Such software can include an interface for communicating with the other modules via the network 105. In some embodiments of the environment of FIG. 1, there can be any number of the clients 110, token servers 115, and tokenization systems 100 connected to the network 105 and communicating with one or more other modules.

The network 105 connecting the various modules is typically the Internet, but can be any network, including but not limited to a local area network (LAN), metropolitan area network (MAN), wide area network (WAN), cellular network, wired network, wireless network, private network, virtual private network (VPN), direct communication line, and the like. The network 106 can also be a combination of multiple different networks.

The client 110 is configured to access date information, for instance as part of a transaction or data record, and is configured to provide the date information to the tokenization system 100. The tokenization system 100 is configured to receive the date information, to tokenize the date information, and to provide tokenized date information back to the client 110 that provided the date information, or to another client 110 or entity (such as a bank server, a merchant, and the like). The tokenization system 100 includes an interface module 120, a date-to-integer conversion module 130, a tokenization engine 140, an integer-to-date conversion module 150, and a database of token tables 160.

The interface module 120 provides an interface that allows an operator of the tokenization system to interact with the modules of the tokenization system 100, and is one means for performing this function. To provide an interface to the \ modules of the tokenization system 100, the interface module 120 is communicatively coupled to the date-to-integer conversion module 130, the tokenization engine 140, the integer-to-date conversion module 150, and the database of token tables 160. An operator can for example specify various parameters that determine the way the date information received by the tokenization system 100 is tokenized. For example, the operator can select via the interface module a token table from the token table database 160 that the tokenization engine 140 then uses to convert a date integer representing date information into a tokenized date integer that represents the tokenized date information. Similarly, an operator can select via the interface module one or more tokenization rules specifying a date input format or date information rules, a type of tokenization, a number of tokenization iterations, or a date output format. In one embodiment, the date-to-integer conversion module 130 and the integer-to-date conversion module 150 may require starting dates for use in converting the date information to an integer and vice versa (as described below). An operator can provide such starting dates via the interface module 120.

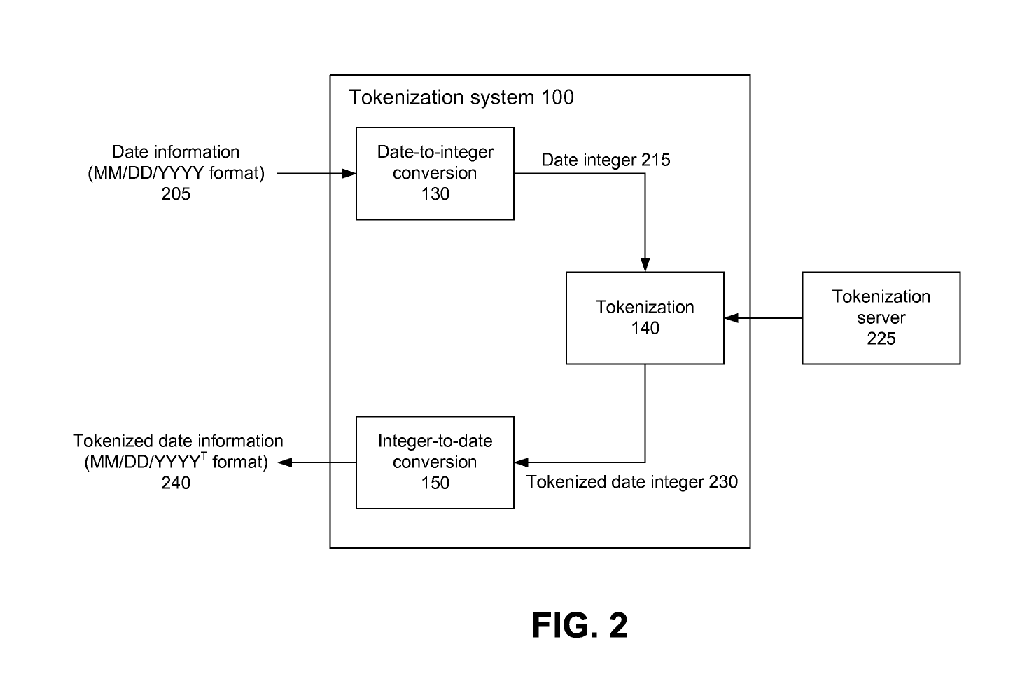

The date-to-integer conversion module 130 is configured to receive input date information and output a date integer, and is one means for performing this function. When the tokenization system 100 receives date information from the client 110, the tokenization system 100 provides the date information to the date-to-integer conversion module 130 to be converted into a date integer 215, as further described below in conjunction with FIG. 2. The date-to-integer conversion module 130 is configured to output the date integer 215 to the tokenization engine 140.

The tokenization engine 140 receives an input date integer, accesses one or more token tables, and tokenizes the input date integer with the accessed token tables, and is one means for performing this function. The tokenization engine 140 is configured to access one or more token tables from the token table database 160 for use in tokenization. In some embodiments, the date-to-integer conversion module 130 and the integer-to-date conversion module 150 are configured to receive starting dates from the token server 115 via the network 105 for use in converting date information into date integers or for use in selecting token tables. The starting dates can be associated with particular token tables and are stored in the token table database 160. By storing these starting dates in the token table database 160, a reference to the associated token tables is created in the token table database 160 such that the starting dates and their referenced token tables can be accessed by the date-to-integer conversion module 130, the tokenization engine 140, and the integer-to-date conversion module 150 for tokenizing date information.

The token table database 160 stores the token tables for use in tokenizing date information, and is one means for performing this function. In one embodiment, the token server 115 is configured to generate and/or provide token tables to the tokenization system 100 for storage in the token table database 160. The token tables can for instance be periodically generated so that the token table database 160 is continuously updated and the token tables stored in the token table database changes over time.

The integer-to-date conversion module 150 is configured to receive the tokenized date integer 230 from the tokenization engine 140, to convert the tokenized date integer 230 into tokenized date information 240, and to output the tokenized date information 240, and is one means for performing this function. An implementation of the integer-to-date conversion module 150 is described below in conjunction with FIG. 2. The tokenization system 100 can transmit the tokenized date information to the client 110 via the network 105.

The tokenization system 100 may be implemented using a single computer, or a network of computers, including cloud-based computer implementations. The computers are preferably server class computers including one or more high-performance CPUs and 128 Gb or more of main memory, as well as 500 Gb to 2 Tb of computer readable, persistent storage, and running an operating system such as LINUX or variants thereof. The operations of the tokenization system 100 as described herein can be controlled through either hardware or through computer programs installed in computer storage and executed by the processors of such servers to perform the functions described herein. The tokenization system 100 includes other hardware elements necessary for the operations described here, including network interfaces and protocols, input devices for data entry, and output devices for display, printing, or other presentations of data. The functions and operations of the tokenization 100 are sufficiently complex as to require implementation on a computer system, and cannot be performed in the human mind simply by mental steps.

### Tokenization of Date Information

FIG. 2 illustrates the data flow within the tokenization system of FIG. 1, according to one embodiment. In this embodiment the data flow includes date data, more generally referred to as date information.

Date information can be protected using format-preserving tokenization. Date information is any data that expresses a date and/or a time in a predefined, fielded format. The embodiment of FIG. 2 illustrates an example tokenization system 100 configured to receive a date information, to tokenize the date information, and to output the tokenized date information in a date format. As illustrated in the embodiment of FIG. 2, the date information 205 received by the tokenization system 100 is in a numeric month/day/year (“MM/DD/YY”) format, where M, D, and Y represent individual digits of the month, date, and year (last two digits). Similarly, in the embodiment of FIG. 2, the tokenized date information 240 outputted by the tokenization system is in the same MM/DD/YY format. The tokenized date information 240 is notated as MM/DD/YY^{T}, where the superscript “T” indicates that the date information has been tokenized.

It should be noted that the tokenization system 100 can receive date information in other formats, and can tokenize the received date information using the principles described herein to output tokenized date information in the same format as received date information. Examples of date formats include a “MM/DD/YYYY”, “DD/MM/YY”, and “DD/MM/YYYY”, as well as alphanumeric formats such as “Month name, Day, Year”, and the like. In other embodiments, the format of the date information 205 received by the tokenization system 100 is different than the format of the tokenized date information 240 output by the tokenization system 100, e.g., the input date information can in a MM/DD/YY format and the output date information can be DD/MM/YYYY^{T}. As noted above the principles described herein with regards to the tokenization of date information including dates are equally applicable to the tokenization of a received date information includes times, for instance a time expressed in a numeric hour/minute/second format or the like, or the combination of a date and time, for instance a date and time in hour/minute/second/month/day/year format or the like.

The tokenization system 100 can be configured to tokenize only date information including dates that fall within a particular date range using a date information validation module (not illustrated in the embodiment of FIG. 2). For example, in one embodiment, the tokenization system is configured to tokenize only date information with dates that fall within the range “Jan. 1, 1800” to “Dec. 31, 2100”. Another example of a restriction can be that the date information can only include the current month or the prior week with respect to the actual date when the date information is tokenized.

Similarly, any restrictions or requirements can be imposed upon date information received by the tokenization system for tokenization. The date information validation module can also be configured to verify that received date information includes valid dates, e.g., all month values are between 1 and 12, days are valid for the number of days in a month, and a day name, or if a day name is given (e.g., Saturday), then the date actually falls on that day. For example, the date information validation module can be configured to reject date information including a date such as “Apr. 31, 1972”, “14/28/91”, or “Friday, Jul. 25, 2012,” since April does not have a 31^{st} day, there is no such thing as a “14^{th}” month, and Jul. 25, 2012 was a Wednesday. Accordingly, the date information validation module can be configured to verify that any received date information is capable of tokenization by the tokenization system 100 (in other words, that received date information only includes dates which represent valid dates, and that the received date information satisfies any requirements or restrictions imposed by the tokenization system 100).

The received date information 205 is converted to a date integer by the date-to-integer conversion module 130. The date-to-integer conversion module 130 can include a mapping function configured to map dates to integers. A mapping function can be either a computational function or a reference function to an entry in a mapping table. For purposes of description the output of the date-to-integer conversion module 130 is called a “date integer.” The mapping table can be a 1-to-1 mapping configured to map each unique received date information to a unique date integer. The date-to-integer conversion module 130 can include a mapping function configured to convert dates to integers. An example of such a mapping function can include a function that maps a date into an integer number of days since a pre-determined start date. For example, a mapping function can convert a date into an integer number of days between the date of the received date information and the date Jan. 1, 0001, or any other date. In this example, converting dates to integer numbers of days starting with 1/1/0001 allows dates from 1/1/0001 to 11/26/2738 to be represented by 6 digits of integers. Thus, a starting date can be selected based on a desired number of digits required to represent a date after the date-to-integer conversion. Any other suitable date to integer conversion function can be used such that the conversion function produces a date integer output based on a received date information input.

Although a date-to-integer conversion using the decimal system is used in the embodiment of FIG. 2, other embodiments may convert received date information into other number systems, for instance binary, hexadecimal, and the like. As discussed above, the conversion of received date information into numeric representations (whether integer, binary, hexadecimal, etc.) can use a conversion function configured to convert the date of the date information into a numeric representation of the number of days between a starting date and the date. Alternatively, the date of received date information can be converted into a numeric string representing the date. For example, the date “Dec. 28, 1981” can be converted into the numeric string “12281981”, which is then tokenized by the tokenization system 100. In addition, dates can be converted into non-numeric strings as well, though such embodiments are not discussed further herein. For the purposes of simplicity, the remainder of the description herein will be limited to embodiments where dates of the received date information are converted to integers before tokenization.

The date-to-integer conversion module 130 outputs the received date information 215 as a date integer, using a pre-determined number of digits (e.g., 6 or less). The date integer is received by a tokenization engine 140, which is configured to tokenize the date integer and output a tokenized date integer 230. As the tokenized date integer is generated based on a token table, the tokenized date integer generally cannot be algorithmically derived by numerical methods from the received date information 205.

The tokenized date integer 230 is received by an integer-to-date conversion module 150, which converts the tokenized date integer 230 into tokenized date information 240, comprising for example a MM/DD/YYYY^{T} format or any other suitable date format. The integer-to-date conversion module 150 can use a mapping function to convert the tokenized date integer into tokenized date information by determining the date representing a number of days equal to the tokenized date integer from a starting date. For example, if the tokenized date integer is “266831”, and if the integer-to-date conversion module 150 is configured to use a starting date of Jun. 17, 1298, the integer-to-date conversion module 150 can output the date “01/14/2029” as the tokenized date information. Alternatively, the integer-to-date conversion module 150 can use a mapping table to map received tokenized date integers to tokenized date information.

The integer-to-date conversion module 150 can use an inverse of the mapping table or mapping function used by the date-to-integer conversion module 130. For example, if the date-to-integer conversion module 130 uses a mapping table or mapping function that maps each date of the date information within a set of dates to an integer within a set of integers (such that the mapping of dates to integers represents a 1-to-1 mapping 1:1), the integer-to-date conversion module 150 can use an inverse of the mapping table or mapping function used by the date-to-integer conversion module 130 that maps each integer in the set of integers to a date in the set of dates. Alternatively, the mapping table or mapping function used by the integer-to-date conversion module 150 can be independent of the mapping table or mapping function used by the date-to-integer conversion module 130. In one embodiment, the format of the received date information 205 and the tokenized date information 240 is the same, though in other embodiments, the formats may be different.

In yet another embodiment, the integer-to-date conversion module 150 can convert a received tokenized date integer into an invalid date (such as “Feb. 35, 1942” and the like) included in the tokenized date information. By mapping a tokenized date integer into an invalid date of the tokenized date information that still maintains a valid date format, the tokenization system 100 can tokenize date information in a way that satisfies an external system's date format constraints but that indicates (through the invalid date value) that the date information is tokenized. For example, a retailer database may only be able to store date information associated with sales in a particular date format (such as the MM/DD/YY format). In this example, by tokenizing the dates into invalid date values in the MM/DD/YY^{T} format (for instance, “02/35/42”), the date information include these dates can be securely stored in the database, and the invalid date values of the stored date information can indicate to an observer of the database that the date information is tokenized. When the observer views the stored tokenized date information, the observer can verify that the date information has been tokenized (for example, due to the impossibility of a 35^{th} day in a month in the previous example), and can determine that the tokenized date information need to be de-tokenized prior to use.

Tokenized date information can be converted into date information including invalid dates by the integer-to-date conversion module 150 during conversion (for instance, tokenized date integers can be mapped to invalid date values) or after conversion (for instance, tokenized date integers can be mapped to valid dates and then converted into invalid dates). Converting valid tokenized date information into invalid tokenized date information can include adding the value 12 to the month portion of the date, and/or adding the value 31 to the day portion of the date, and the like.

The tokenization engine 140 performs tokenization on the received date information 215 using one or more token tables received from the tokenization server 225. The tokenization engine may receive token tables from the tokenization server once, periodically (for instance, once an hour or once a day), or in response to requesting token tables from the tokenization server 225. Any type of tokenization may be used by the tokenization engine 140, such as DTP (data-type preserving encryption), DLT, and SLT, as described in the above “Tokenization Overview” section. Further, date information may be tokenized multiple times in chaining/overlapping fashion.

The tokenization system 100 can be configured to preserve one or more original portions of received date information 205 during tokenization. For example, the tokenization system 100 may be configured to tokenize only one or more of the month, the day, and the year of the date in the received date information. In such an embodiment, the date-to-integer conversion module 130 converts only the portions of the received date that are to be tokenized into a date integer. For example, if only the month and the year are to be tokenized, the date-to-integer conversion module can combine the month and year together and convert the combined month and year into a single date integer. Alternatively, the tokenization system 100 can convert the month and year components to date integers separately, and can subsequently combine the date integers or leave them separate. The tokenization engine 140 then tokenizes the date integer portions of the received date information into one tokenized date integer or into a plurality of tokenized date integer portions (one for each date integer portion of the received date if date integer portions of the received date are kept separate).

The integer-to-date conversion module 150 then converts the tokenized date integer or tokenized date integer portions into a date format, and combines these converted portions with the maintained original portions of the received date information to produce tokenized date information 240. For example, the tokenization system 100 may be configured to preserve the year component of received dates, and only tokenize the month and day components. In this example, the month and day portions of the received date “May 16, 1982” can be converted into a date integer (for instance, using a mapping table that maps a month and day to an integer number of days since January 1, May 16 maps to “136”), can tokenize the date integer into a tokenized date integer (for instance, from “136” to the token “251”), can convert the tokenized date integer to a month and day format (for instance, “251” is converted to “September 8”, since September 8 is 251 days after January 1), and can combine this month and day with the original year of the received date to form the final tokenized date (for instance, “Sep. 8, 1982”) in the date information. Thus, in addition to maintaining the format of received and tokenized date information, original portions of the date information can also be preserved.

The tokenization engine 140, in tokenizing a first portion of received date information, can use a second portion of received date information as an initialization vector for the tokenization process. For example, if the tokenization system 100 tokenizes a day and month of a received date information but preserves a year of the received date information, the tokenization engine 140 can use the year of the received date information as an initialization vector when tokenization the date and month in the received date information. In tokenization, initialization vectors can be used to modify date information to be tokenized prior to tokenization, or can be used to “seed” tokenization by selecting one or more token tables or other tokenization parameters based on the initialization vectors. In addition to using portions of the date information as initialization vectors, external data can be used as all or part of an initialization vector, such as initialization parameters provided by the owner of date information. In one embodiment, data used as an initialization vector, such as preserved date information as described above, can be tokenized using an additional static token table.

As discussed above, these principles apply equally to times in the received date information, and combinations of dates and times. In response to receiving both a time and a date as part of the date information, the tokenization system 100 can tokenize the received time and the received date separately, or can tokenize the combination of the time and the date. Times can be received by the tokenization system 100 in various levels of precisions, for instance in terms of hours, minutes, seconds, milliseconds, microseconds, or any other denotation or measurement of time.

Date and time data received as part of the date information by the tokenization system 100 for tokenization can be protected by encrypting the date and time data prior to tokenization. The date and time data can be encrypted prior to receipt by the tokenization system 100 (for instance, by a module external to the tokenization system), or can be encrypted by the tokenization system upon receipt. The date and time data can be decrypted after tokenization by the tokenization system 100 (for instance, before outputting the tokenized date and time), or can be outputted in encrypted form for subsequent decryption by an external module. Any suitable form of encryption can be used, and might be adapted to fit the requirements imposed by the tokenization system 100.

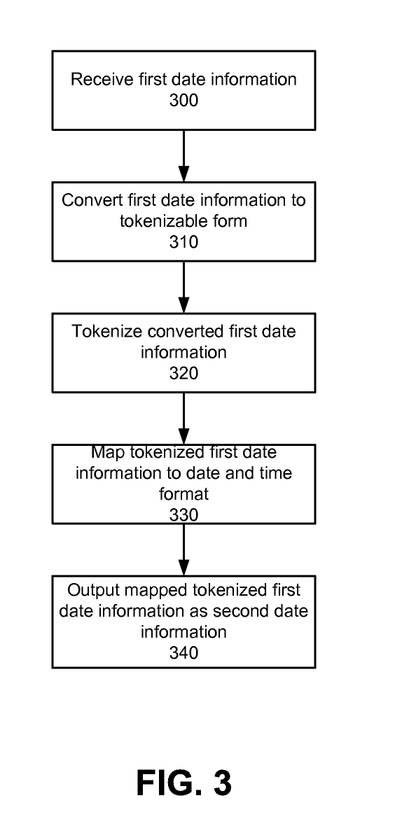

FIG. 3 is a chart that illustrates the process of tokenizing date information, according to one embodiment. First date information is received 300 by the tokenization system. The date information can include date and/or time data. In other embodiments, the date information can include a plurality of dates and/or times. The date and time data can be in any suitable format as described above. The first date information is converted into a tokenizable form, e.g., a first date integer. The converted first date information is then tokenized 320. The tokenization (not shown in FIG. 3) for example includes mapping the first date integer to a tokenized second date integer using one or more token tables as described above. Any type of tokenization can be used, such as SLT or DLT tokenization. The tokenized first date information is mapped 330 to a date and time format, for instance by converting the tokenized first date information into a tokenized date integer, and then converting the tokenized date integer into second date information. The second date information is then output 340.

### Additional Configuration Considerations

The present invention has been described in particular detail with respect to one possible embodiment. Those of skill in the art will appreciate that the invention may be practiced in other embodiments. First, the particular naming of the components and variables, capitalization of terms, the attributes, data structures, or any other programming or structural aspect is not mandatory or significant, and the mechanisms that implement the invention or its features may have different names, formats, or protocols. Also, the particular division of functionality between the various system components described herein is merely exemplary, and not mandatory; functions performed by a single system component may instead be performed by multiple components, and functions performed by multiple components may instead performed by a single component.

It should be noted that various functionalities described herein may be combined in ways not explicitly described. For instance, data can be tokenized to include one or more use rules such that the resulting tokenized data fails a validation test and is verifiable. Thus, while self aware tokenization and verifiable tokenization are described separately, aspects of each may be performed in concert, and the resulting tokenized data can be both self aware tokenized data and verifiable tokenized data.

Some portions of above description present the features of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “determine” refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may include a general-purpose computer selectively activated or reconfigured by a computer program stored on a non-transitory computer readable medium that can be accessed by the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of computer-readable storage medium suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, the present invention is not described with reference to any particular programming language. It is appreciated that a variety of programming languages may be used to implement the teachings of the present invention as described herein, and any references to specific languages are provided for invention of enablement and best mode of the present invention.

The present invention is well suited to a wide variety of computer network systems over numerous topologies. Within this field, the configuration and management of large networks include storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

What is claimed is:

1. A method for data protection in a computer system, comprising:
receiving first date information at a date information input of the computer system, the first date information representing a first date;
converting the first date information into a first date integer representing a number of days from a first starting date to the represented first date;
tokenizing the first date integer using one or more token tables to produce a second date integer;
converting the second date integer into second date information, the second date information representing a second date occurring a number of days equal to the second date integer after a second starting date; and
outputting the second date information.

2. The method of claim 1, wherein the received first date information and the outputted second date information comprise a MM/DD/YYYY format.

3. The method of claim 1, further comprising verifying that the represented first date falls within a date range.

4. The method of claim 1, further comprising verifying that the represented first date represents a valid date.

5. The method of claim 1, wherein converting the first date information into a first date integer comprises using a mapping function configured to map received date information into date integers representing a number of days since the first starting date.

6. The method of claim 1, wherein tokenizing the first date integer comprises querying the one or more token tables with the first date integer and receiving a token, the received token comprising the second date integer.

7. The method of claim 1, wherein tokenizing the first date integer comprises querying the one or more token tables with a portion of the first date integer, receiving a token, and replacing the portion of the first date integer with the received token to produce the second date integer.

8. The method of claim 1, wherein the first starting date and the second starting date comprise the same date.

9. The method of claim 1, wherein the first date information further comprises a first time, and converted first date integer represents a number of seconds from a first starting date and time to the represented first date and time.

10. A method for data protection, comprising:
receiving first time information representing a first time;
converting the first time information into a first integer representing a number of seconds from a first starting time to the represented first time;
tokenizing the first integer using one or more token tables to produce a second integer;
converting the second integer into second time information, the second time information representing a second time occurring a number of seconds equal to the second integer after a second starting time; and
outputting the second time information.

11. The method of claim 10, wherein the first time information further represents a first date, and wherein the second time information further represents a second date.

12. A tokenization system for data protection, comprising:
an interface module configured to receive first date information, the first date information representing a first date, and further configured to output a second date information;
a date-to-integer conversion module configured to convert the first date information into a first date integer representing a number of days from a first starting date to the represented first date;
a tokenization engine configured to tokenize the first date integer using one or more token tables to produce a second date integer; and
a integer-to-date conversion module configured to convert the second date integer into the second date information, the second date information representing a second date occurring a number of days equal to the second date integer after a second starting date.

13. The tokenization system of claim 12, wherein the received first date information and the outputted second date information comprise a MM/DD/YYYY format.

14. The tokenization system of claim 12, wherein the date-to-integer conversion module is further configured to verify that the represented first date falls within a date range.

15. The tokenization system of claim 12, wherein the date-to-integer conversion module is further configured to verify that the represented first date represents a valid date.

16. The tokenization system of claim 12, wherein converting the first date information into a first date integer comprises using a mapping function configured to map received date information into date integers representing a number of days since the first starting date.

17. The tokenization system of claim 12, wherein tokenizing the first date integer comprises querying the one or more token tables with the first date integer and receiving a token, the received token comprising the second date integer.

18. The tokenization system of claim 12, wherein tokenizing the first date integer comprises querying the one or more token tables with a portion of the first date integer, receiving a token, and replacing the portion of the first date integer with the received token to produce the second date integer.

19. The tokenization system of claim 12, wherein the first starting date and the second starting date comprise the same date.

20. The tokenization system of claim 12, wherein the first date information further comprises a first time, and converted first date integer represents a number of seconds from a first starting date and time to the represented first date and time.
